(19) United States
(12) Patent Application Publication
(10) Pub. No.: US 2007/0187395 A1
(43) Pub. Date: Aug. 16, 2007

(54) Induction heating apparatus for strip materials with variable parameters

(76) Inventors: Jean Lovens, Embourg (BE); Michel Fontaine, Aywaille (BE)

Correspondence Address: PHILIP O. POST;INDEL, INC., PO BOX 157, RANCOCAS, NJ, 08073, US

(21) Appl. No.: 11/650,145

(22) Filed: Jan. 5, 2007

Related U.S. Application Data
(60) Provisional application No. 60/757,353, filed on Jan. 9, 2006.

(51) Int. Cl. H05B 6/10

(52) U.S. Cl. 219/645

(57) ABSTRACT

One or more sections of a solenoidal induction coil are moved relative to the surface of a strip passing through the coil as one or more parameters of the strip change to affect the impedance of the load circuit, while the output frequency of the power supply providing power to the coil via a capacitive element is changed so that the power supply's load circuit continues to operate at substantially resonant frequency.

### CROSS REFERENCE TO RELATED APPLICATIONS

This application claims the benefit of U.S. Provisional Application No. 60/757,353, filed Jan. 9, 2006, hereby incorporated by reference in its entirety.

### FIELD OF THE INVENTION

The present invention relates to electric induction heating of a strip material particularly in applications where the width of the strip material, or another parameter, changes to alter the electrical impedance of the load circuit.

### BACKGROUND OF THE INVENTION

A flexible solenoidal induction coil, when connected to an ac power supply, can be used to inductively heat a workpiece passing through the coil. The flexible coil is of particular use when the workpiece has a changing crosss sectional dimension. In this arrangement the coil can be flexed to maintain a constant distance between the coil and the cross section of the workpiece presently passing through the coil. For example if the workpiece is a camshaft, irregularly shaped cams (features of the workpiece) will be spaced apart from each other along the shaft (workpiece). As the cam shaft passes through the coil for induction heat treatment, the flexible coil can be dynamically changed in shape-by attachment to suitable linear motion actuators that alter the cross sectional shape of the coil, for example, from circular to oval, to conform to the cross sectional shape of the feature of the workpiece passing through the coil.

For electric induction heating of a continuous strip material, the strip can be passed through a solenoidal coil that is powered from ac power source 112 as shown in FIG. 1. Capacitance of tuning capacitor C_{TUNE}, impedance of solenoidal coil L_{COIL} and the resistance of the strip material 90, which is magnetically coupled with the primary power circuit, substantially comprise the load circuit impedance. For certain applications the coil must accommodate strip materials of varying width. Rolls of materials having different widths may be sequentially fed through the coil, either as individual rolls, or with consecutive rolls of varying widths welded together at their ends to pass continuously through the coil. Power induced in the strip material is substantially equal to the electrical resistance of the material multiplied by the square of the current supplied to the coil from the ac power supply. As the width of the strip increases, the resistance of the strip increases. Since applied power is equal to the square of the current supplied to the coil multiplied by the resistance of the strip, as the resistance increases and the supplied current does not change, applied power will linearly increase, as will the product output rate (that is, weight of the strip material heated per unit time measure, for example, in Tons (T) per hour (hr)) as graphically illustrated in FIG. 2(a). In some applications there is a desire to maintain the product output rate at a constant value after a particular level of applied power is reached. As illustrated in FIG. 2(b), between increasing strip widths w₁ and w₂, product output rate (power) increases linearly from y₁ to y₂. If the width of the strip further increases, the output level remains constant at y₂. To keep the output rate constant, load resistance must be kept constant.

One object of the present invention is to selectively achieve a constant rate of production of inductively heated strip materials having different widths when the width of the strip changes by changing the distance between the strip and a solenoidal coil used to inductively heat the strip while keeping the load circuit operating at substantially resonant frequency by modulating the output frequency of the power supply providing power to the load circuit.

Another object of the present invention is to selectively achieve a constant rate of production of inductively heated strip materials having one or more different parameters that affect the electrical impedance of the inductive heating circuit by changing the distance between the strip and a solenoidal coil used to inductively heat the strip while keeping the load circuit operating at substantially resonant frequency by modulating the output frequency of the power supply providing power to the inductive heating circuit.

### BRIEF SUMMARY OF THE INVENTION

In one aspect the present invention is an apparatus and method of inductively heat treating strips when at least one parameter of the strips changes to change the impedance of the inductive load heating circuit. The apparatus comprises an ac power supply providing power to the load circuit. The load circuit comprises a capacitive element, a solenoidal induction coil having at least one flexible section, and at least one means for moving the at least one flexible section of the coil. A strip moves through the coil so that the strip is magnetically coupled with the load circuit. As the strip moves through the coil, the at least one flexible section of the coil is moved to change the load impedance. The output of the power supply is frequency modulated to change the output frequency as the at least one flexible coil section is moved so that the load circuit continues to operate at substantially resonant frequency.

Other aspects of the invention are set forth in this specification and the appended claims.

### BRIEF DESCRIPTION OF THE DRAWINGS

The foregoing brief summary, as well as the following detailed description of the invention, is better understood when read in conjunction with the appended drawings. For the purpose of illustrating the invention, there is shown in the drawings exemplary forms of the invention that are presently preferred; however, the invention is not limited to the specific arrangements and instrumentalities disclosed in the following appended drawings:

FIG. 1 is a prior art apparatus for induction heating of a strip material.

FIG. 2(a) graphically illustrates the increase in applied induction power and rate of production of inductively heated strip material with the prior art apparatus as the width of the heated strip increases.

FIG. 2(b) graphically illustrates the increase in applied induction power, and rate of production of inductively heated strip material, as the width of the heated strip increases to a selected value, and is then maintained at a constant applied induction power and rate of production over a range of further increasing strip widths with the induction heating apparatus of the present invention.

FIG. 3 is a cross sectional view of one example of the induction heating apparatus of the present invention used to inductively heat a strip having a first width, w₁.

FIG. 4 is a cross sectional view of one example of the induction heating apparatus of the present invention used to inductively heat a strip having a second width, w₃, which is greater than the width of the strip in FIG. 3, prior to adjustment of one or more flexible sections of the induction coil.

FIG. 5 is a cross sectional view of one example of the induction heating apparatus of the present invention used to inductively heat a strip having the second width, and after adjustment of the one or more flexible sections of the induction coil to reduce the resistance of the primary load circuit.

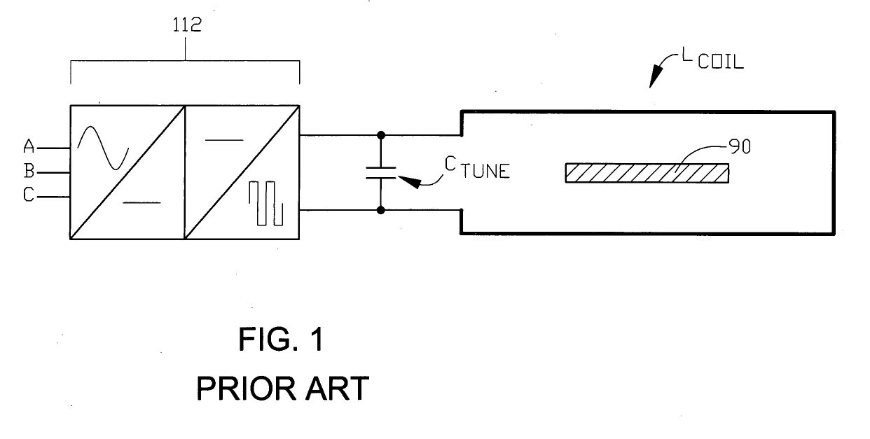

### DETAILED DESCRIPTION OF THE INVENTION

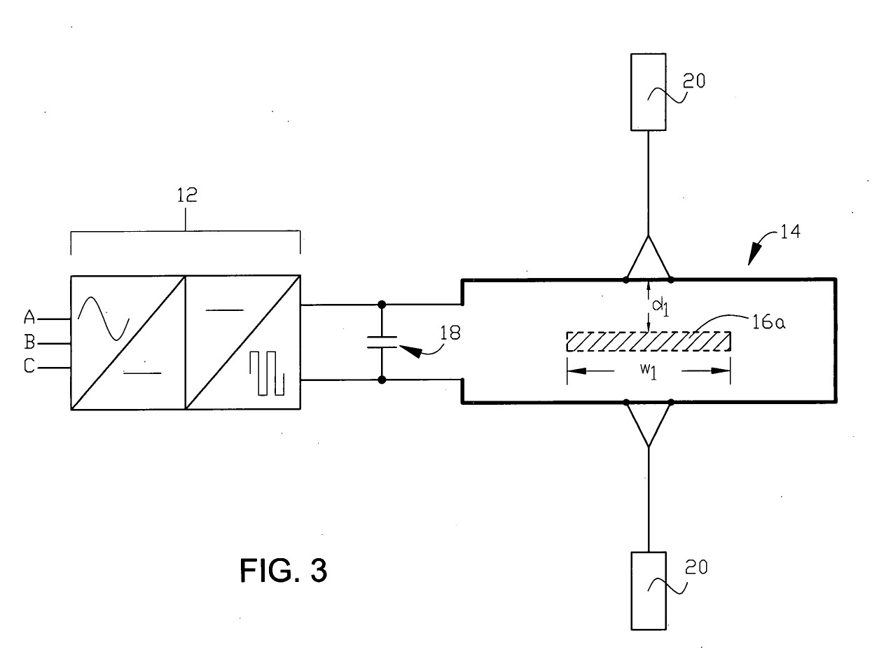

Referring now to the drawings, wherein like numerals indicate like elements, there is shown in FIG. 3 through FIG. 5 one example of the induction heating apparatus of the present invention. In FIG. 3 power supply 12 supplies ac power to solenoidal induction coil 14. Strip 16a (shown in dashed outline) passes through the coil and is heated by electric induction when ac current from the power supply flows through the coil to establish a magnetic field that couples with the strip. A means for moving the one or more sections of the coil is provided so that the distance between at least one of the surfaces of the strip and the one or more coil sections, for example, d₁ in FIG. 3, can be selectively changed. The means for moving the one or more coil sections may comprise a manual mechanism, an actuator 20, as shown in the figures, or other suitable device. The actuator may be, for example, an electrically or hydraulically powered linear actuator.

Power supply 12 outputs variable frequency ac power and can be an ac inverter fed from a dc rectifier having an input from utility power. Tuning capacitor 18 forms a resonant load circuit with solenoidal coil 14 and the equivalent electrical impedance of strip 16a by magnetic coupling with the primary load circuit. The output frequency of the power supply is selected so that the load circuit comprising the tuning capacitor, the induction coil and impedance of the strip reflected into the load circuit by magnetic coupling, which, in combination, is referred to as combined load impedance Z_{load}, operates substantially at resonant frequency.

In FIG. 3, strip 16a having width w₁, is inductively heated with the coil in a first position as shown in the figure. This physical configuration results in a first load circuit impedance, Z_{load1}, which requires the power supply to operate with an output frequency, f₁, so that the load circuit is operating substantially at resonance.

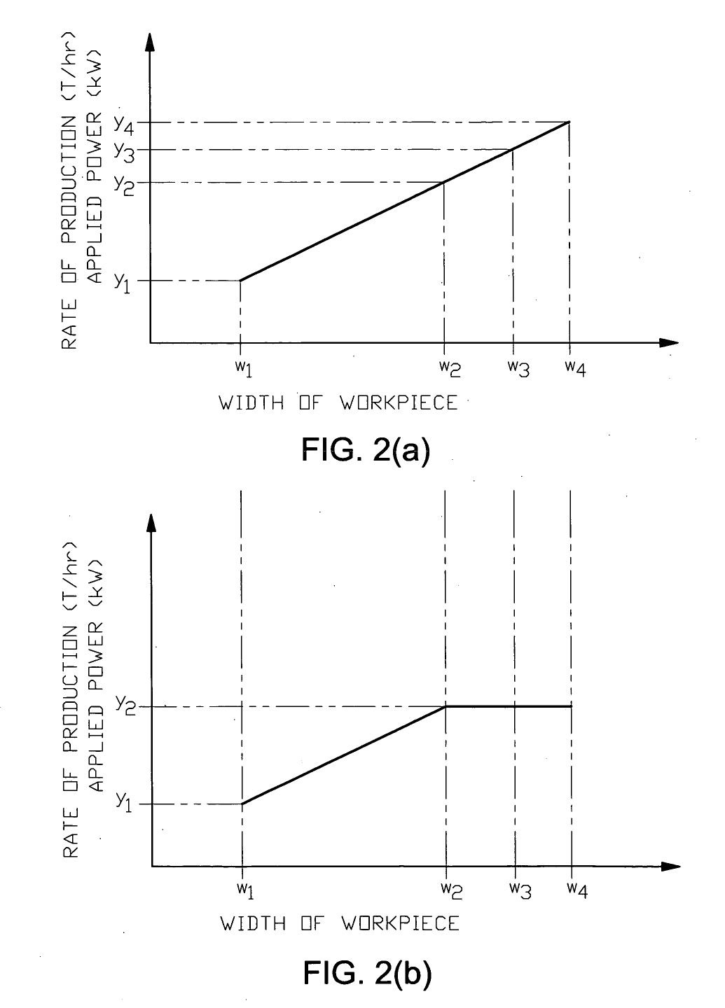

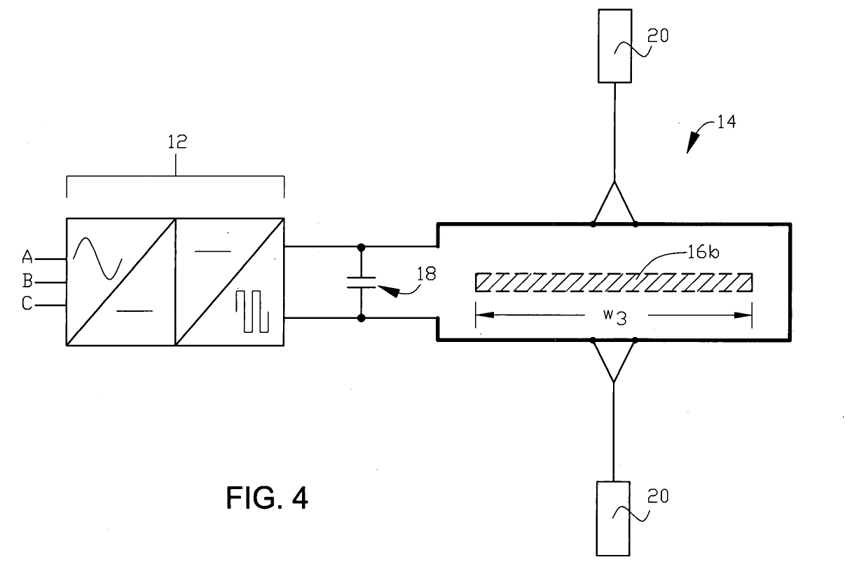

In FIG. 4, strip 16b having width w₃, which is greater than width w₁, of strip 16a in FIG. 3, is inductively heated by passing the strip through coil 14. If the tuning capacitance and inductance of the coil in the load circuit remain the same, load circuit impedance will change to a second value of load circuit impedance, Z_{load2}, since the impedance of the strip reflected into the primary load circuit by magnetic coupling increases. If the output current of the power supply remains the same, applied power, as graphically shown in FIG. 2(a), will continue to increase, as will the rate of production of the strip.

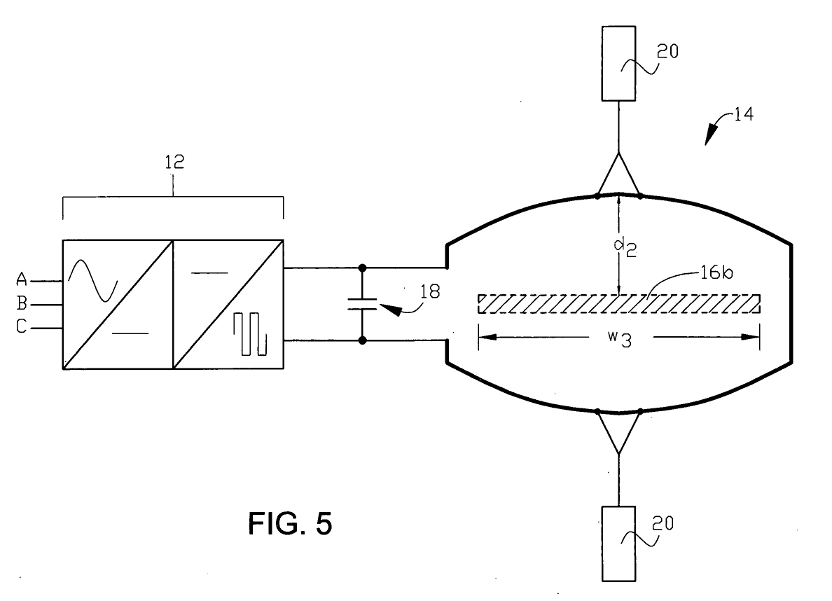

With the induction heating apparatus of the present invention, as shown in FIG. 5, actuators 20 are used to move one or more sections of coil 14 to a second position that is farther away (distance d₂) from a surface of the strip than distance d₁ in FIG. 3, which will reduce the impedance of the strip reflected into the primary load circuit by magnetic coupling. With suitable movement of the coil and change (modulation) in output frequency of the power supply, applied power and rate of production, can be maintained constant, for example, between strip widths w₂ and W₄ as graphically shown in FIG. 2(b). For example, with the induction heating device of the present invention, the output frequency of power supply 12 can be changed to f₂, which is the resonant frequency with the coil in the position shown in FIG. 5.

Suitable feedback means, such as but not limited to, sensing of the actual position of the coil, or electrical sensing of instantaneous load power, can be used to adjust the output frequency of the power supply so that the load circuit is powered at resonant frequency as the position of the coil changes. A processing system comprising a computer executing a program to control the applied power to the load circuit may be used with suitable input and output devices to control the movement of the coil and output frequency of the power supply as the width of the strip changes.

In the above examples of the invention, changing of the width of the strip represents one parameter that will change the electrical impedance of the load circuit when the parameter changes. Other such parameters are, for example, the composition of the strip material and the composition of any coating on the strip as it passes through the solenoidal coil. In other examples of the invention, the induction heating apparatus of the present invention may be used to increase and decrease the applied power and rate of production of inductively heated strip as one or more of such parameters changes over a range by changing the position of the coil and modulating the output frequency of the power supply as described above.

Solenoidal coil 14 may comprise a singular coil that is flexible for movement between positions. In other examples of the invention the coil may comprise a number of sections, one or more of which may be flexible with means for moving the flexible coil section from one position to another. Coil 14 may comprise other arrangements, such as but not limited to, multiple coils, so long as at least one section of a coil can be moved to change the load impedance. While the above non-limiting example of the invention illustrates moving opposing coil sections, other examples of the invention include arrangements with one or more moveable coil sections not necessarily symmetrically arranged about the strip.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto, and changes may be made without departing from the scope and spirit of the invention in its aspects.

1. An induction heating apparatus for inductively heating a strip, the apparatus comprising an ac power supply providing power to a load circuit comprising a capacitive element, a solenoidal induction coil, and the strip moving through the coil, the strip magnetically coupled with the load circuit by the magnetic field established by the flow of ac current through the solenoidal induction coil,
the improvement comprising,
a means for moving at least one or more sections of the solenoidal coil to selectively change the electrical impedance of the load circuit when one or more parameters of the strip changes, and
a means for modulating the output frequency of the ac power supply when the at least one or more sections of the solenoidal coil is moved to maintain constant applied power to the load circuit at substantially resonant frequency.

2. The apparatus of claim 1 wherein the one or more parameters of the strip include the width of the strip, the composition of the strip, and the composition of a coating applied to the strip prior to inductively heating the strip.

3. The apparatus of claim 1 wherein the means for moving the at least one or more sections of the solenoidal coil comprises at least one powered actuator.

4. The apparatus of claim 3 wherein the at least one powered actuator and the means for modulating the output frequency of the ac power supply are controlled by a processing system.

5. The apparatus of claim 4 further comprising one or more position sensors to input the position of at least one or more sections of the solenoidal coil to the processing system.

6. The apparatus of claim 4 further comprising one or more electric power sensors to input the instantaneous electrical load power to the processing system.

7. The apparatus of claim 4 further comprising one or more position sensors to input the position of at least one or more sections of the solenoidal coil to the processing system and one or more electric power sensors to input the instantaneous electrical load power to the processing system.

8. A method of heating a strip by electric induction, the method comprising the steps of passing the strip through a solenoidal coil connected to an ac power supply by a capacitive element to form a load circuit; selectively altering the distance between at least one or more sections of the coil and the strip responsive to a change in one or more parameters of the strip changing the impedance of the load circuit, and modulating the output frequency of the power supply to keep the load circuit at substantially resonant frequency.

9. The method of claim 8 further comprising the steps of sensing the position of at least one or more sections of the coil; inputting the sensed position to a processing system; and outputting a change in output frequency signal from the processing system, the signal responsive to the sensed position, to the power supply to modulate the output frequency to substantially resonant frequency.

10. The method of claim 8 further comprising the steps of sensing the instantaneous power of the load circuit; inputting the sensed instantaneous power to a processing system; and outputting a change in output frequency signal from the processing system, the signal responsive to the sensed instantaneous power, to the power supply to modulate the output frequency to substantially resonant frequency.

11. The method claim 8 further comprising the steps of sensing the position of at least one or more sections of the coil; sensing the instantaneous power of the load circuit; inputting the sensed position and instantaneous power to a processing system; and outputting a change in output frequency signal from the processing system, the signal responsive to the sensed position and instantaneous power, to modulate the output frequency to substantially resonant frequency.

12. A method of maintaining a constant rate of weight of inductively heated continuous strip per unit time as one or more weight changing parameters of the continuous strip changes, the method comprising the steps of passing the strip through a solenoidal coil connected to an ac power supply by a capacitive element to form an inductive heating load circuit, selectively changing the distance between one or more coils sections of the coil and a surface of the continuous strip responsive to a change in the one or more weight changing parameters of the continuous strip, and modulating the output frequency of the power supply to keep the load circuit at substantially resonant frequency.

13. The method of claim 12 further comprising the steps of sensing the position of at least one or more sections of the coil; inputting the sensed position to a processing system; and outputting a change in output frequency signal from the processing system, the signal responsive to the sensed position, to the power supply to modulate the output frequency to substantially resonant frequency.

14. The method of claim 12 further comprising the steps of sensing the instantaneous power of the load circuit; inputting the sensed instantaneous power to a processing system; and outputting a change in output frequency signal from the processing system, the signal responsive to the sensed instantaneous power, to the power supply to modulate the output frequency to substantially resonant frequency.

15. The method claim 12 further comprising the steps of sensing the position of at least one or more sections of the coil; sensing the instantaneous power of the load circuit; inputting the sensed position and instantaneous power to a processing system; and outputting a change in output frequency signal from the processing system, the signal responsive to the sensed position and instantaneous power, to modulate the output frequency to substantially resonant frequency.
